(19) United States
(12) Patent Application Publication
(10) Pub. No.: US 2019/0338832 A1
(43) Pub. Date: Nov. 7, 2019

(54) STAINLESS STEEL ROLLER CHAIN WITH INCREASED DURABILITY

(71) Applicant: U.S. Tsubaki Holdings, Inc., Wheeling, IL (US)

(72) Inventors: Charles R. Monty, North Granby, CT (US); Michael C. Hogan, Ludlow, MA (US); Robert J. Hogan, Ludlow, MA (US)

(21) Appl. No.: 16/405,003

(22) Filed: May 7, 2019

Related U.S. Application Data
(60) Provisional application No. 62/667,902, filed on May 7, 2018.

(51) Int. Cl. F16G 13/06; B21L 9/02

(52) U.S. Cl. CPC F16G 13/06; B21L 9/02

(57) ABSTRACT

Disclosed is an improved stainless steel roller chain and methods for manufacturing the stainless steel roller chain, such that the improved stainless steel roller chain maintains the corrosion resistant properties of stainless steel while exhibiting the strength and durability of carbon steel.

### CROSS REFERENCE TO RELATED APPLICATIONS

This application claims priority from and the benefit of U.S. Provisional Patent Application Ser. No. 62/667,902, entitled “STAINLESS STEEL ROLLER CHAIN WITH INCREASED DURABILITY,” filed May 7, 2018, which is hereby incorporated by reference in its entirety for all purposes.

### BACKGROUND

Industrial roller chain is used for a variety of applications, including power transmission, food processing, bulk conveying, product packaging, and more. Many potential industrial roller chain applications require the strength and wear resistant properties achieved with a carbon steel material composition, but also the corrosion resistant properties associated with a stainless steel material composition. Conventional roller chains provide only one or the other of these properties; specifically, conventional roller chains do not possess both strength and corrosion resistance while conforming to the ASME (American Society of Mechanical Engineers) B29.1 standard, which outlines standards for Precision Power Transmission Roller Chains, Attachments, and Sprockets, such as minimum ultimate tensile strengths, and sprocket tooth section profile dimensions.

One conventional roller chain product is the alloy steel “AS” (or 600) series of stainless steel roller chain, which has hardened pins and bushings that provide some degree of wear resistance, but cannot match the strength of a carbon steel roller chain. Other types of steel, such as common stainless “SS” chromium/nickel (or 304) series of steel, also fails to match the strength of carbon steel. Thus, there is a need for a roller chain that can combine the corrosion resistance of stainless steel and the strength of carbon steel materials.

### SUMMARY

The present disclosure relates generally to stainless steel roller chains. More particularly, an improved stainless steel roller chain and methods for manufacturing the stainless steel roller chain are provided, such that the improved stainless steel roller chain maintains the corrosion resistant properties of stainless steel while exhibiting the strength and durability of carbon steel.

The improved stainless steel roller chain obtains this unique combination of characteristics through innovative design and material selection, coupled with a process layering technique. In some instances, the design and product can be described as a “Super Stainless” roller chain.

In disclosed examples, a stainless steel roller chain with increased durability includes a plurality of steel bushings; a plurality of steel rollers; a plurality of steel pins; and a plurality of steel side plates, wherein one or more of the plurality of steel pins or the plurality of steel plates is defined by a fine surface finish created by a precision forming process. Application of a surface treatment to one or more of the plurality of steel bushings, the plurality of steel rollers, the plurality of steel pins or the plurality of steel plates yields an enhanced corrosion resistance for the stainless steel roller chain.

In some examples, the plurality of steel bushings and the plurality of steel rollers are secured to the plurality of steel side plates by press-fitting the plurality of steel pins to the plurality of steel side plates to form a stainless steel roller chain achieving a yield strength and a durability that are similar to roller chain plates with a carbon steel material composition.

In examples, the surface treatment comprises a passivation process to increase corrosion resistance and reduce ferrite from the surface.

In some examples, the surface treatment comprises a chemical passivation process to increase corrosion resistance and reduce ferrite from the surface. In some examples, the surface treatment comprises an impact surface treatment to increase a strength of the steel of the one or more of the plurality of steel bushings, the plurality of steel rollers, the plurality of hardened steel pins or the plurality of steel plates. In some examples, the impact surface treatment comprises a shot peening impact process.

In some examples, each steel side plate of the plurality of hardened steel side plates is subjected to a forming process to define a shape of each steel side plate.

In some examples, one or more of the plurality of hardened steel bushings, the plurality of hardened steel rollers, the plurality of hardened steel pins or the plurality of hardened steel plates has a maximum allowable load capacity greater than that of conventional stainless steel.

In some examples, the conventional stainless steel is one of 600 series alloy steel and 304 series stainless steel. In some examples, steel for one or more of the plurality of steel bushings, the plurality of steel rollers, the plurality of steel pins or the plurality of steel plates is a hardenable steel hardened to a level of 40-65 HRC.

In some disclosed examples, a method of manufacturing a stainless steel roller chain with increased durability and corrosion resistance includes forming a plurality of steel bushings; forming a plurality of steel rollers; forming a plurality of steel pins and a plurality of steel plates via a precision forming process to yield a fine surface finish; and applying a surface treatment to one or more of the plurality of steel bushings, the plurality of steel rollers, the plurality of steel pins or the plurality of steel plates to yield an enhanced corrosion resistance for the stainless steel roller chain.

In some examples, the method includes forming the plurality of steel side plates and further includes defining a shape of each steel side plate.

In some examples, the precision forming process includes one or more of a machining process, a laser cutting process, a waterjet cutting process, or a blanking process.

In some examples, the method includes forming the plurality of steel side plates by heat treating the plurality of steel side plates to lower a hardness of each steel side plate prior to the precision forming process.

In some examples, the method includes applying the surface treatment by applying a passivation process to increase corrosion resistance and reduce ferrite from the surface.

In some examples, the method includes securing the plurality of steel bushings and the plurality of steel rollers to the plurality of steel side plates by press-fitting the plurality of steel pins to the plurality of steel side plates to form a stainless steel roller chain achieving a yield strength and a durability that are similar to roller chain plates with a carbon steel material composition.

In disclosed examples, a stainless steel roller chain with increased durability includes a plurality of steel bushings; a plurality of steel rollers; a plurality of steel pins; and a plurality of steel side plates, wherein one or more of the plurality of steel pins or the plurality of steel plates is defined by a fine surface finish created by a precision forming process, and wherein application of a chemical passivation process surface treatment to one or more of the plurality of steel bushings, the plurality of steel rollers, the plurality of steel pins or the plurality of steel plates yields an enhanced corrosion resistance and reduced ferrite from the surface of the stainless steel roller chain.

In examples, the stainless steel roller chain retains properties of strength and enhanced corrosion resistance at operating temperatures up to 930° F. (500° C.).

### DRAWINGS

FIG. 1 illustrates an example improved stainless steel roller chain, in accordance with aspects of this disclosure.

FIG. 2 is a flowchart of an example method of manufacturing an improved stainless steel roller chain, in accordance with aspects of this disclosure.

FIG. 3 is an example chart illustrating a relationship of load bearing strength and corrosion resistance for a variety of materials used in the manufacturing of rolled chain.

The figures are not necessarily to scale. Where appropriate, similar or identical reference numbers are used to refer to similar or identical components.

### DETAILED DESCRIPTION

The present disclosure describes systems and methods for an improved stainless steel roller chain. The improved stainless steel roller chain achieves the combination of the strength and durability of a carbon steel roller chain and the full corrosion resistance of a stainless steel roller chain using specifically engineered dimensions, materials, and process layering.

A roller chain, or bush roller chain, is a type of chain commonly used to drive transmissions for mechanical power in a variety of settings, including industrial and agricultural machinery, conveyors, printing presses, cars, motorcycles, and bicycles, to name but a few. Roller chains consist of a series of short cylindrical bushings and/or rollers that are held together by side plates. In operation, the roller chain is driven by a toothed wheel or sprocket, for simple, reliable, and efficient means of power transmission. An example is a conveyor type roller chain defined by a series of alternately assembled roller links and pin links in which the pins articulate inside the bushings such that the rollers turn freely on the bushings. The pins and bushings can be secured to respective link plates by press-fitting, for instance.

Often, standards require the roller chain to have a certain level of corrosion resistance. This can be due to the environment in which the roller chain is operating, as well as the type of product exposed to the chain, such as food processing. However, materials that are effective in resisting corrosion have decreased durability and/or load bearing capacity. The trade-off then becomes having to choose one characteristic over the other, when one of them is more valuable to a particular application, or required by safety or other standards.

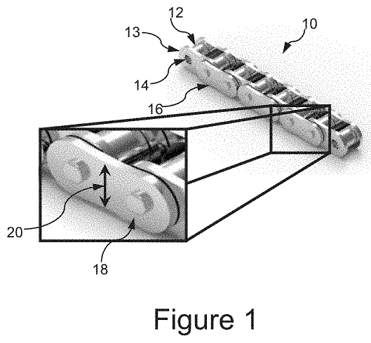

FIG. 1 shows an example of improved stainless steel roller chain 10, with enhanced side plates 16. For example, the side plate 16 design can include a hardenable grade of stainless steel. The side plate 16 can be designed with or without an enhanced physical contour. In some examples, the hardenable grade of stainless steel includes hardness levels of 40-65 HRC grade. Other grades of hardened stainless steel, however, are contemplated in the scope of the present disclosure. In examples, the dimensions of the plate 16 around pin 18 and bushings 12 are designed to provide increased tensile and fatigue strength without any effect on sprocket compatibility versus a conventional roller chain. In some examples, one or more of the dimensions are enlarged relative to conventional roller chains, while being within threshold limits for conventional sprocket compatibility. The standard roller dimensions can include, but are not limited to, roller dimensions associated with RS11SS chain types with a roller diameter of 0.090 in (2.286 mm) and RS240 chain type with a roller diameter of 1.875 in (47.63 mm), as well as standard other standard chain types including roller diameters between the RS11SS and RS240. Other standard dimensions (bushings, pins, plates, spacing, etc.) may also be similar to conventional chain types. For example, a center part width 20 (i.e. “a wide waist”) of the plate 16 may be only slightly narrowed in comparison to the dimension of the plate 16 that surrounds the pin 18 (e.g., with a central width of about 90%).

In some examples, the side plates are hardened to achieve a tensile and yield strength that is comparable to roller chain plates with a traditional carbon steel material composition (e.g., with a hardness of 40-48 HRC). The side plate 16 is arranged external to an interior plate 13, having bushings 12 therebetween. The pins 18 are fitted through holes 14 to secure opposing side plates 16.

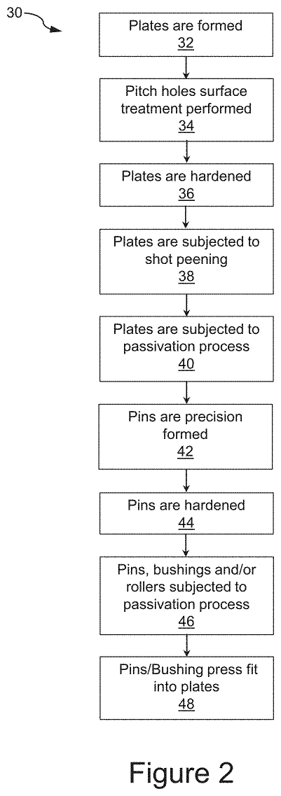

In addition to improvements to the design, process techniques disclosed herein further enhance the combination of durability and corrosion resistance of the disclosed stainless steel chain. FIG. 2 illustrates a method 30 for manufacturing the improved stainless steel roller chain disclosed herein. As shown in block 32 of FIG. 2, the plates (e.g., interior plate 13 and side plate 16) are formed through a forming process including, but not limited to, machining, laser cutting, waterjet cutting, and a blanking process, for example. In some examples, the forming process is subjected to a heat treatment process to condition the precipitation-hardened steel to the desired level of hardness (e.g., a lowest possible hardness level), such as on attachment plates (e.g., a bent attachment plate, link plate). In some examples, this allows the parts to be formed with precision tolerances without any material tearing on or around the formed features. In some examples, the plate can be formed with the “wide waist” design shown in FIG. 1. This can be achieved via one or more of the aforementioned forming processes.

In block 34, pitch holes (e.g., hole 14) are precision formed to achieve a fine surface finish (such that debris will not collect on the surface and/or interaction with other surfaces will not cause undue wear, grating, erosion, abrasion, friction, etc.) throughout the pitch hole to maximize the engagement and surface area interfacing the pins and bushings while mitigating fatigue precipitation points, such as by a machining and/or chemical process. This is achieved through means of precision milling, a two-step pierce process with die clearances significantly finer than the industry norms, or by ballizing/swaging techniques in order to achieve a smooth finish while imparting compressive residual stresses. As disclosed herein, the forming process may employ a heat treatment process to condition the precipitation-hardened steel to a desired level of hardness, allowing the parts to be formed with precision tolerances without any material tearing on or around the formed features.

In block 36, the plates are hardened to achieve a yield strength that is comparable to roller chain plates with a traditional carbon steel material composition. In some examples, the plates can be hardened to a 40-65 HRC according to the Rockwell hardness tester classification. However, a lower, higher, and/or different hardness standard can be used as appropriate.

In block 38, the plates are subjected to additional strengthening processes, such as shot peening (or other suitable technique). In block 40, the plates are subjected to a passivation process as an operation to further enhance corrosion resistance.

In block 42, pins (e.g., pins 18) are precision ground to a fine surface finish to achieve a resilient and smooth bearing surface. In block 44, the pins are hardened to achieve a yield strength that is comparable to roller chain pins with a traditional carbon steel material composition. In some examples, the pins, bushings and/or rollers are subjected to a passivation process as an operation (at times the final operation) to further enhance corrosion resistance, as shown in block 46. This combination of these features on the wear bearing surfaces results in a stainless steel chain with a wear life that is similar or equal to carbon steel chain under like conditions (i.e. similar loads, speeds, lubrication condition, etc.). In some examples, the pins (or other components) are hardened to a desired hardness level. Example hardness levels include, but are not limited to, 40-65 HRC.

In block 48, the pin is press-fit into the pin link plate, and the bushing is press-fit into the roller link plate. The resulting improved stainless steel roller chain includes plural bushings and rollers between interior and exterior plates, held by linking to the plates, such that a sprocket can fit between adjacent rollers to drive the improved stainless steel roller chain. This arrangement provides a level of integrity in the improved stainless steel roller chain that greatly exceeds conventional stainless steel designs, and is consistent with strength and durability associated with conventional carbon steel varieties.

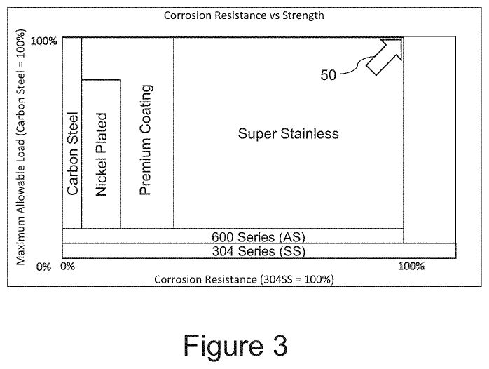

When assembled, the improved stainless steel roller chain achieves the combination of corrosion resistance and strength, as illustrated in the graph of FIG. 3. The improved stainless steel roller chain fully meets the corrosion resistance of 600 series stainless steel roller chain as well as the load capacity of traditional high strength carbon steel roller chain, respectively, all of which is unprecedented in the industry.

In the example shown in FIG. 3, a chart illustrates a relationship of load bearing strength and corrosion resistance for a variety of materials used in the manufacturing of rolled chain. As shown, 600 series (AS) steel and 304 series (SS) exhibit favorable corrosion resistance, yet only provide a fraction of the load bearing capacity of carbon steel, nickel plated steel, and/or steel products with premium coatings. Conversely, carbon steel, as well as nickel plated steel, steel with premium coatings, etc., provides a greater strength profile, yet possess very little corrosion resistance. The improved stainless steel roller chain disclosed herein provides the combination of strength, durability and corrosion resistance the other materials/designs lack. Thus, the improved stainless steel roller chain approaches full alloy steel strength and full stainless steel corrosion resistance, as illustrated via arrow 50.

The improved stainless steel roller chain is also capable of accommodating standard and/or custom attachment link plates designed for traditional carbon steel roller chain. Additional or alternative heat treatment processes may be employed to condition the precipitation-hardened steel to the lowest possible hardness during a manufacturing or processing step, allowing the parts to be formed with precision tolerances without any material tearing on or around the formed features. Following complete manufacturing including a hardening process, these custom improved stainless steel roller chain link plates have a resulting strength that is similar to an equivalent hardened carbon steel part, but with the advantage of enhanced corrosion resistance.

Thus, in examples, the components of the improved stainless steel roller chain (e.g., pins, bushings, rollers, side plates, and interior plates) are hardened by one or more techniques prior to assembly to further improve the strength, durability and/or load bearing properties of the improved stainless steel chain. For instance, designs of the pin, bushing, and/or roller (e.g., the load bearing components) can utilize special corrosion-resistant highly hardenable grades of stainless steel, which are further designed and subjected to the advanced process techniques disclosed herein. In some examples, the forming processes and techniques disclosed herein are applicable to a wide variety of hardened stainless steel for the one or more of the components. In some non-limiting examples, types of hardened stainless steel can include one or more of austenitic stainless steels, ferritic stainless steels, martensitic stainless steels, including any number of alloys, as well as a variety of grades of hardened stainless steel.

In some examples, the application of compressive forces (through processes such as shot-peening or other similar processes) on the surface of the component, followed by a polish and/or passivation process, provides a significant improvement in fatigue life and corrosion resistance over the base materials. For instance, the polish/passivation process removes any remaining surface imperfections and free ferrite from the surface to enhance the chromium/nickel surface layer for one of the most beneficial forms of passivation for stainless steel. The resulting stainless steel chain exhibits an improved level of corrosion resistance.

For example, passivation techniques condition materials to become “passive,” thereby limiting the effects of environmental corrosives. In some examples, the passivation process creates a layer of material applied as a coating as a result of a chemical reaction with the base material. Additionally or alternatively, the coating is built from spontaneous oxidation when exposed to elements in the air. As a technique, passivation is the use of a light coat of a protective material, such as metal oxide, to create a shell against corrosion. Passivation strengthens and preserves the appearance of metallics. Additionally or alternatively, when exposed to air, many metals naturally form a hard, relatively inert surface, as in the tarnish of silver.

Shot peening is a process used to produce a compressive residual stress layer on metallic surfaces, thereby modifying the mechanical properties of the base metal. In some examples, a surface of the material is impacted with shot (e.g., round metallic, glass, or ceramic particles) with force sufficient to create plastic deformation of the material. The technique strengthens and relieves stress in metal components.

The improved stainless steel roller chain assembly and compositions have additional advantages over conventional roller chains. For example, the disclosed combination of material types not only resists typical externally caused corrosion, but also has not exhibited observable galvanic corrosion during corrosion testing.

The press-fit of the pin into the pin link plate, and the bushing into the roller link plate, provides a level of integrity in the improved stainless steel roller chain that greatly exceeds conventional stainless steel designs, and also provides roller chain that is more resilient to imperfections than conventional stainless steel roller chain and has consistent strength and durability normally associated with only conventional carbon steel varieties. As a result, the improved stainless steel roller chain is more resilient to imperfections in a variety of applications, including resistance to misalignments and twisting.

The side plates are assembled in a specific orientation that allows the natural plate “cupping” to act favorably when the roller chain is subjected to a tensile load, thereby increasing the fatigue strength, a result of one or more of the aforementioned forming processes. For example, machining can encompass a variety of processes in which a material is cut (or machined) into a desired shape and/or size by a controlled material-removal and/or refining process. Laser cutting employs technologies and techniques using a laser to cut materials, such as metallics in industrial manufacturing applications. A water jet cutter (or waterjet), is a cutting tool capable of cutting a variety of materials using a high-pressure water, or a mixture of water and an abrasive substance, which may be employed during fabrication of metallic parts. Blanking is a metal fabricating process, during which a metal workpiece is removed from the primary metal strip or sheet when it is punched. For the improved stainless steel roller chain described herein, the removed material (e.g., the blank) is the side plate.

Furthermore, the hardness specifications between the pins, bushings, and plates are designed to prevent galling, or “cold-welding”, that can occur in traditional stainless steel roller chains, for example, as a form of wear caused by adhesion upon contact between sliding surfaces of the roller and bushing. Galling is particularly troubling when the roller chain is operating under heavy loads. For example, aluminum is a metal that will gall very easily, whereas annealed (softened) steel is slightly more resistant to galling. By contrast, steel that is fully hardened is very resistant to galling.

As a result of the process, design and arrangement of components, the improved stainless steel roller chain disclosed herein experiences increased integrity versus conventional stainless steel roller chains, and consistent with carbon steel roller chain.

The improvements over conventional roller chains in the presently disclosed stainless steel roller chain are achieved through precision manufacturing and assembly of optimized components. The result is a combination of strength and wear resistant properties of carbon steel materials and the corrosion and temperature resistant properties of stainless steel material, while maintaining full conformance to the ASME B29.1, such that the improved stainless steel roller chain can replace any existing roller chains without modifications to an application or OEM machine.

The improved stainless steel roller chain has a fully stainless steel composition without factory pre-lubrication or surface coating. As such, it is as equally suitable as existing stainless steel chain products for clean and sanitary applications (such as food interface).

The stainless steel construction of the improved stainless steel roller chain, combined with the disclosed performance-enhancing features, provide the improved stainless steel roller chain with enhanced strength and wear properties compared to conventional roller chains, even at elevated temperatures (i.e. approaching 930° F. or 500° C.).

The improved stainless steel roller chain will add value to a variety of applications, including, but not limited to, food processing, chemical exposure, and ovens, where existing available products currently have limited service life due to either poor corrosion resistance or their inherently lower strength. Such “Super Stainless” steel chain is expected to excel in these conditions.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present roller chains, methods and/or systems have been described with reference to certain implementations, it will be understood by those skilled in the art that various changes may be made and equivalents may be substituted without departing from the scope of the present method and/or system. For example, block and/or components of disclosed examples, including methods and/or processes, may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A stainless steel roller chain with increased durability, comprising:
a plurality of steel bushings;
a plurality of steel rollers;
a plurality of steel pins; and
a plurality of steel side plates, wherein a surface of one or more of the plurality of steel pins or the plurality of steel plates has a fine surface finish created by a precision forming process, and
wherein application of a surface treatment to one or more of the plurality of steel bushings, the plurality of steel rollers, the plurality of steel pins or the plurality of steel plates yields an enhanced corrosion resistance for the stainless steel roller chain.

2. The stainless steel roller chain of claim 1, wherein the plurality of steel bushings and the plurality of steel rollers are secured to the plurality of steel side plates by press-fitting the plurality of steel pins to the plurality of steel side plates to form a stainless steel roller chain achieving a yield strength and a durability similar to roller chain plates with a carbon steel material composition.

3. The stainless steel roller chain of claim 1, wherein the surface treatment comprises a passivation process to increase corrosion resistance and reduce ferrite from the surface.

4. The stainless steel roller chain of claim 1, wherein the surface treatment comprises a chemical passivation process to increase corrosion resistance and reduce ferrite from the surface.

5. The stainless steel roller chain of claim 1, wherein the surface treatment comprises an impact surface treatment to increase a strength of the steel of the one or more of the plurality of steel bushings, the plurality of steel rollers, the plurality of hardened steel pins or the plurality of steel plates.

6. The stainless steel roller chain of claim 5, wherein the impact surface treatment comprises a shot peening impact process.

7. The stainless steel roller chain of claim 1, wherein the precision forming process further comprises defining a shape of each steel side plate.

8. The stainless steel roller chain of claim 7, wherein the precision forming process comprises one or more of a machining process, a laser cutting process, a waterjet cutting process, or a blanking process.

9. The stainless steel roller chain of claim 7, wherein each steel side plate is subjected to a heat treatment to lower a hardness of each steel side plate prior to the precision forming process to condition precipitation-hardened steel of the steel side plates to desired level of hardness.

10. The stainless steel roller chain of claim 1, wherein one or more of the plurality of hardened steel bushings, the plurality of hardened steel rollers, the plurality of hardened steel pins or the plurality of hardened steel plates has a maximum allowable load capacity greater than that of conventional stainless steel.

11. The stainless steel roller chain of claim 10, wherein the conventional stainless steel is one of 600 series alloy steel and 304 series stainless steel.

12. The stainless steel roller chain of claim 1, wherein steel for one or more of the plurality of steel bushings, the plurality of steel rollers, the plurality of steel pins or the plurality of steel plates is a hardenable steel hardened to a level of 40-65 HRC.

13. A method of manufacturing a stainless steel roller chain with increased durability and corrosion resistance, the method comprising:
forming a plurality of steel bushings;
forming a plurality of steel rollers;
forming a plurality of steel pins and a plurality of steel plates via a precision forming process to yield a fine surface finish; and
applying a surface treatment to one or more of the plurality of steel bushings, the plurality of steel rollers, the plurality of steel pins or the plurality of steel plates to yield an enhanced corrosion resistance for the stainless steel roller chain.

14. The method of manufacturing a stainless steel roller chain of claim 13, wherein forming the plurality of steel side plates further comprises defining a shape of each steel side plate.

15. The method of manufacturing a stainless steel roller chain of claim 14, wherein the precision forming process comprises one or more of the machining process, the laser cutting process, the waterjet cutting process, or the blanking.

16. The method of manufacturing a stainless steel roller chain of claim 15, wherein forming the plurality of steel side plates further comprises heat treating the plurality of steel side plates to lower a hardness of each steel side plate prior to the precision forming process.

17. The method of manufacturing a stainless steel roller chain of claim 13, wherein applying the surface treatment further comprises applying a passivation process to increase corrosion resistance and reduce ferrite from the surface.

18. The method of manufacturing a stainless steel roller chain of claim 13, further comprising securing the plurality of steel bushings and the plurality of steel rollers to the plurality of steel side plates by press-fitting the plurality of steel pins to the plurality of steel side plates to form a stainless steel roller chain achieving a yield strength and a durability that are similar to roller chain plates with a carbon steel material composition.

19. A stainless steel roller chain with increased durability, comprising:
a plurality of steel bushings;
a plurality of steel rollers;
a plurality of steel pins; and
a plurality of steel side plates, wherein one or more of the plurality of steel pins or the plurality of steel plates is defined by a fine surface finish created by a precision forming process, and
wherein application of a chemical passivation process surface treatment to one or more of the plurality of steel bushings, the plurality of steel rollers, the plurality of steel pins or the plurality of steel plates yields an enhanced corrosion resistance and reduced ferrite from the surface of the stainless steel roller chain.

20. The stainless steel roller chain of claim 19, wherein the stainless steel roller chain retains properties of strength and enhanced corrosion resistance at operating temperatures up to 930° F.
